(19) United States
(12) Patent Application Publication
(10) Pub. No.: US 2025/0369545 A1
(43) Pub. Date: Dec. 4, 2025

(54) Fitting for Use with a Refrigerant Hose

(71) Applicant: Parker-Hannifin Corporation, Cleveland, OH (US)

(72) Inventor: Connor M. Weide, Mayfield Heights, OH (US)

(21) Appl. No.: 19/078,373

(22) Filed: Mar. 13, 2025

Related U.S. Application Data
(60) Provisional application No. 63/654,947, filed on Jun. 1, 2024.
(60) Provisional application No. 63/687,573, filed on Aug. 27, 2024.

(51) Int. Cl. F16L 33/22; F16L 33/30

(52) U.S. Cl. CPC F16L 33/227; F16L 33/30

(57) ABSTRACT

An example fitting includes: a head portion; and a barbed portion extending axially from the head portion, wherein the barbed portion includes: at least one distal barb having a curved edge, and at least one proximal barb having a sharp edge.

### CROSS REFERENCE TO RELATED APPLICATION

The present application claims priority to U.S. Provisional Patent Application No. 63/654,947, filed on Jun. 1, 2024, and U.S. Provisional Patent Application No. 63/687,573, filed on Aug. 27, 2024, the entire contents of all of which are herein incorporated by reference as if fully set forth in this description.

### BACKGROUND

Compared to hydraulic or liquid coolant hoses, refrigerant hoses and fittings used in two-phase refrigeration systems where the refrigerant is converted, at least during a portion of a refrigeration cycle, into vapor should be configured to form a seal that prevents leakage of refrigerant in a vapor state. Such sealing may be accomplished via including a barrier layer in the hose and compression of the hose via the fitting.

In conventional configurations, a fitting that mates with a refrigerant hose may be crimped tightly to achieved a desired compression that forms a seal. For example, the fitting may be crimped in two thin bands around the shell of the fitting in order to tightly compress the hose mating with the fitting. Importantly, crimping should be performed without compromising the thin barrier layer within the hose, which can be challenging.

Also, crimping machines are not easily portable, and thus hose assemblies are typically made in a dedicated location before being taken to the place of installation. Further, in some applications (e.g., computer server applications), hundreds or thousands of server blades may be used, with correspondingly thousands of hose-fitting connections to make. Having to crimp such number of hose-fitting connections may be prohibitive.

As such, it may be desirable to have a different fitting configuration that enables quick connections with a hose and forming a sealed connection with the hose, while reducing the likelihood of compromising the barrier layer of the hose. It may also be desirable to enable mounting or coupling the hose to the fitting in a field environment as opposed to a remote location. It is with respect to these and other considerations that the disclosure made herein is presented.

### SUMMARY

The present disclosure describes implementations that relate to a fitting for use with a refrigerant hose.

In a first example implementation, the present disclosure describes a fitting for use with a refrigerant hose. The fitting includes: a head portion; and a barbed portion extending axially from the head portion, wherein the barbed portion includes: at least one distal barb having a curved edge, and at least one proximal barb having a sharp edge.

In a second example implementation, the present disclosure also describes an assembly of the fitting of the first example implementation and a refrigerant hose.

In a third example implementation, the present disclosure also describes a method of forming the assembly of the second example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a perspective view of a refrigerant hose, according to an example implementation.

FIG. 2 illustrates a partial cross-sectional side view of a fitting, according to an example implementation.

FIG. 3 illustrates a partial cross-sectional side view of another fitting one barb with a curved edge and two barbs with sharp edges, according to an example implementation.

FIG. 4 illustrates mounting the refrigerant hose of FIG. 1 to the fitting of FIG. 2 or the fitting of FIG. 3 to form an assembly, according to an example implementation.

FIG. 5 is a flowchart of a method of forming the assembly of FIG. 4, according to an example implementation.

### DETAILED DESCRIPTION

Within examples, disclosed herein is a fitting. The fitting has a head portion and a barbed portion extending axially from the head portion. The barbed portion has at least one distal barb having a curve edge to facilitate insertion into a hose. The barbed portion also has at least one proximal barb having a sharp edge to facilitate gripping an interior surface of the hose.

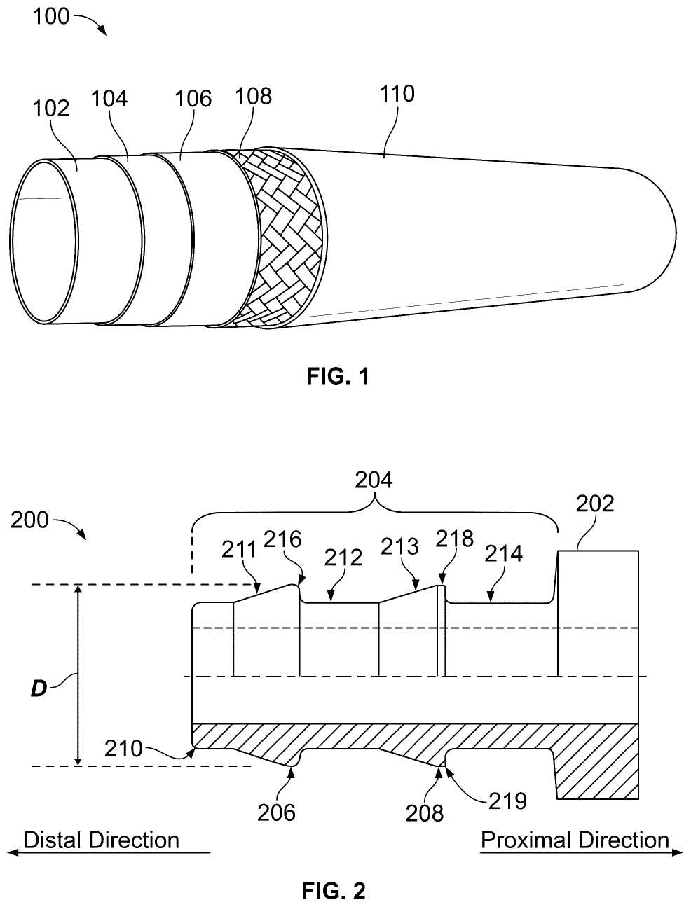

FIG. 1 illustrates a perspective view of a refrigerant hose 100, according to an example implementation. The refrigerant hose 100 is configured to be used in a phase refrigeration application where the refrigerant is converted to a vapor state during a portion of the refrigeration cycle. For example, the refrigerant hose 100 can be used in two-phase cooling applications, where the coolant undergoes a phase change and becomes a gas.

In the example implementation of FIG. 1, the refrigerant hose 100 is a multi-layered hose having an elastomeric inner tube 102, a barrier layer 104, an elastomeric layer 106, a braided layer 108, and an outer cover layer 110.

The elastomeric inner tube 102 is a smooth tube as shown in FIG. 1 and is made of an elastomeric material (e.g., synthetic rubber). The elastomeric inner tube 102 is configured to create a tight, high-integrity seal between the refrigerant hose 100 and a mating fitting (e.g., fitting 200 or fitting 300 described below). The wall thickness of the elastomeric inner tube 102 can be configured to provide sufficient structure to form a leak free coupling to a fitting (e.g., a barb fitting).

The barrier layer 104 surrounds, and is in direct contact with (or is applied to), the elastomeric inner tube 102. The barrier layer 104 is a thin barrier configured to provide low refrigerant permeation rate.

Particularly, two-phase coolants currently used include highly fluorinated olefins (HFPOs), and such refrigerants can affect many elastomers through absorption, and may thus degrade tube materials over time, which could cause leakage or permeation. The barrier layer 104 is thus made of a material that reduces the permeation loss. For example, the barrier layer 104 can be made of a polymer material including polyamide, copolyester, polyvinylidene fluoride, or polyvinylidene difluoride (PVDF) to reduce a rate of permeation of coolant. As an example for illustration, these materials and configuration can achieve a target permeation rate for the refrigerant hose 100 that is less than 1.5 kilogram per square meter per year (kg/m\hat{ }2/Yr). This target permeation rate is based on the surface area of the barrier layer 104 and measured at the maximum operating temperature and pressure. In another example, however, the barrier layer 104 can be made of Nylon.

The elastomeric layer 106 surrounds, and is in direct contact with, the barrier layer 104. The elastomeric layer 106 can be made of synthetic rubber, for example. The elastomeric layer 106 is configured to provide flexibility to the refrigerant hose 100, and may also provide insulation (e.g., thermal insulation). The elastomeric layer 106 may further provide protection to the barrier layer 104.

The braided layer 108 is configured as a structural reinforcement layer that is provided as a braided structure wound, and/or wrapped around (and in direct contact with) the elastomeric layer 106. In an example, the braided layer 108 can include a plurality of layers, where the thickness and/or number of reinforcement layers can be selected based on the desired mechanical properties, including a desired level of flexibility.

In an example, the braided layer 108 can be formed as a braid of fibers (e.g., synthetic fiber), configured as alternating interwoven fibers. In an example braided configuration, the braid can be a one over, one under configuration, a two over, two under configuration, or any other configuration. In an example, the fibers can have interstices or gaps between adjacent fibers.

The outer cover layer 110 surrounds, and is in direct contact with, the braided layer 108 such that the outer cover layer 110 is an outermost layer of the refrigerant hose 100. The outer cover layer 110 is also made of an elastomeric material such as synthetic rubber.

The outer cover layer 110 is configured to provide abrasion, scuff, and/or impact resistance and protects the underlying structure (e.g., other layers of) of the refrigerant hose 100. The outer cover layer 110 also provides resistance against chafing, e.g., wear of the refrigerant hose 100 due to rubbing against metallic surfaces or edges, for example. As such, the outer cover layer 110 is characterized as being anti-chafing. Further, dimensions (e.g., thickness) of the outer cover layer 110 can be selected to allow the refrigerant hose 100 to have a desired level of flexibility.

As mentioned above, the barrier layer 104 is configured to prevent or substantially reduce permeation of vapor refrigerant. The structural integrity of the barrier layer 104 is thus important to maintain.

The refrigerant hose 100 is configured to be mounted or coupled to a fitting (e.g., a fitting mounted to a manifold or connected to other components of a refrigeration system). It may be desirable to configure the fitting in a manner that provides a sufficient grip with the refrigerant hose 100 and provides compression of the barrier layer 104 to enhance prevention of vapor permeation, while reducing the likelihood of compromising or damaging the barrier layer 104. It may also be desirable for the fitting to facilitate mounting the refrigerant hose 100 thereto in a quick manner to be suitable for applications where a large number of hose-fitting connections is to be made.

FIG. 2 illustrates a partial cross-sectional side view of a fitting 200, according to an example implementation. The fitting 200 is configured as a generally cylindrical body having a head portion 202 and a barbed portion 204 extending axially from the head portion 202. The body can be made of brass or stainless steel as examples. An outer diameter of the barbed portion 204 is smaller than the outer diameter of the head portion 202.

The term “barb” is used generally herein to indicate a ridge or bump that is configured to grip the inside of the elastomeric inner tube 102 of the refrigerant hose 100 to form a seal between the fitting 200 and the refrigerant hose 100.

The barbed portion 204 of the fitting 200 has a distal barb 206 and a proximal barb 208. Particularly, the barbed portion 204 has a distal straight portion 210, followed by a first ramp 211 that leads to the distal barb 206, which is followed by an intermediate straight portion 212 interposed between the distal barb 206 and a second ramp 213 that leads to the proximal barb 208. A proximal straight portion 214 separates, or is interposed between, the head portion 202 and the proximal barb 208.

Notably, the distal barb 206 has a curved edge 216 to reduce friction with the elastomeric inner tube 102 and facilitate insertion of the fitting 200 into the refrigerant hose 100. On the other hand, the proximal barb 208 has a sharp edge 218 (straight edge). The sharp edge 218 is characterized by a sharp corner 219 (back corner), formed at a transition from the sharp edge 218 to the proximal straight portion 214. With this configuration, the proximal barb 208 facilitates gripping the interior peripheral surface of the elastomeric inner tube 102 of the refrigerant hose 100 and enhances retention of the refrigerant hose 100 to the fitting 200.

The term “sharp corner” is used herein to indicate that, to the extent the sharp corner 219 has any curvature or radius, such curvature or radius is an order of magnitude (e.g., 2-20 times) smaller than a respective curvature or radius of the curved edge 216 of the distal barb 206. As an example for illustration, if the curved edge 216 has a radius between 0.01 and 0.015 inch, the radius of the sharp corner 219 is between 0.002 and 0.006 inch. All dimensions mentioned herein are examples for illustration, and are not meant to be limiting. The dimensions are also scaled up or down based on the size of the refrigerant hose 100.

An outer diameter of the distal barb 206 (labelled “D” in FIG. 2) is based on the inner diameter Din of the elastomeric inner tube 102 of the refrigerant hose 100. The outer diameter D is configured for optimal compression of the layers of the refrigerant hose 100 to enhance sealing, without compromising the barrier layer 104 of the refrigerant hose 100.

In an example, compression of the refrigerant hose 100 can be measured as a percentage of the original wall thickness of the refrigerant hose 100, where the wall is radially displaced by the barbs (e.g., the distal barb 206 and the proximal barb 208) of the fitting 200. For instance, the compression can be determined by the following equation:

$$Compression = \frac{( D - {D}_{in} )}{{D}_{out} - {D}_{in}}$$

where, as mentioned above, D is the outer diameter of the barbs (the distal barb 206 and the proximal barb 208), Din is the inner diameter of the elastomeric inner tube 102, an Dout is the outer diameter of the refrigerant hose 100 (e.g., of the cover layer 110).

When measured in this way, an ideal or optimal compression is between 30-39%. Factors that affect the upper and lower limits of this compression range include the force required to insert the barbs, which increases as the barb outer diameter D increases, and the maximum internal forces (pressure) or external forces (tension) that the assembly of the refrigerant hose 100 and the fitting 200 can withstand before the barbs are ejected. Such maximum internal forces decrease as the barb outer diameter D decreases.

The outer diameter of the distal barb 206 is substantially the same as, or substantially equal to, the outer diameter of the proximal barb 208. The term “substantially the same” or “substantially equal to” is used herein to indicate that the outer diameters are the same but due to manufacturing tolerances, the diameters may be within a threshold percentage (e.g., 1-5%) of each other.

Although the fitting 200 has one barb (the distal barb 206) with the curved edge 216 and one barb (the proximal barb 208) with the sharp edge 218 and the sharp corner 219, more barbs can be used for other sizes of fittings. For example, more than one barb with a curved edge can be used, and/or more than one barb with a sharp edge and corner can be used.

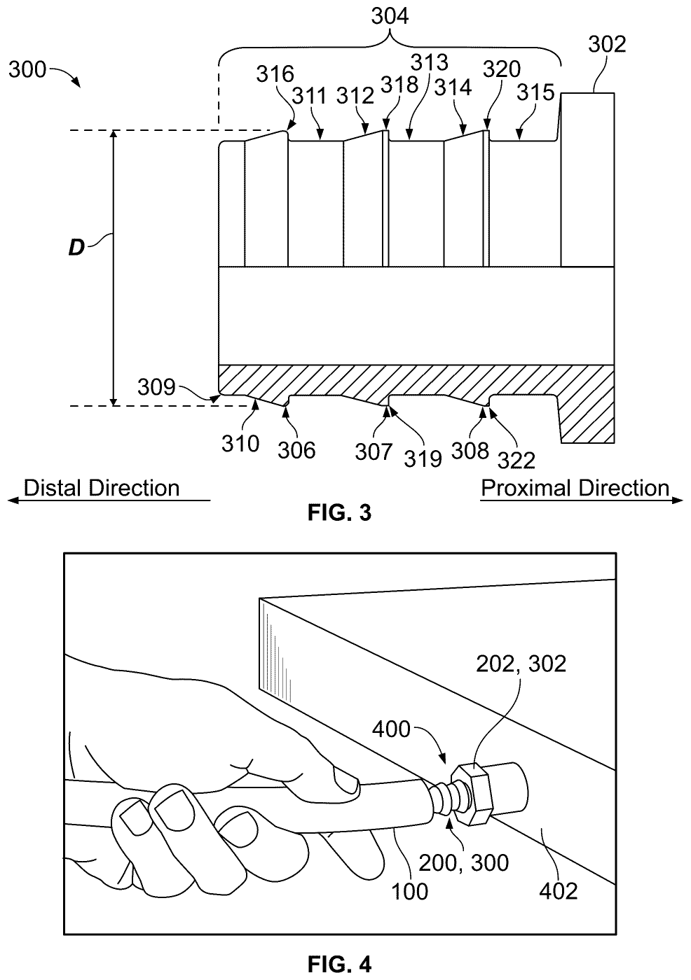

FIG. 3 illustrates a partial cross-sectional side view of another fitting 300 having one barb with a curved edge and two barbs with sharp edges, according to an example implementation. Similar to the fitting 200, the fitting 300 is configured as a generally cylindrical body having a head portion 302 and a barbed portion 304 extending axially from the head portion 202. The body can be made of brass or stainless steel as examples. An outer diameter of the barbed portion 304 is smaller than the outer diameter of the head portion 302.

The barbed portion 304 of the fitting 300 has a distal barb 306, a first proximal barb 307, and a second proximal barb 308. The first proximal barb 307 is axially interposed between the distal barb 306 and the second proximal barb 308. Further, the outer diameter of the distal barb 306 is substantially the same as the outer diameter of the proximal barbs 307, 308.

Particularly, the barbed portion 304 has a distal straight portion 309, followed by a first ramp 310 that leads to the distal barb 306, which is followed by a first intermediate straight portion 311 interposed between the distal barb 306 and a second ramp 312 that leads to the first proximal barb 307. Similarly, a second intermediate straight portion 313 is interposed between the first proximal barb 307 and a third ramp 314 that leads to the second proximal barb 308. A proximal straight portion 315 separates, or is interposed between, the head portion 302 and the second proximal barb 308.

Notably, the distal barb 306 has a curved edge 316 to reduce friction with the elastomeric inner tube 102 and facilitate insertion into the refrigerant hose 100. On the other hand, the first proximal barb 307 has a sharp edge 318 characterized by a sharp corner 319 (back corner), formed at a transition from the sharp edge 318 to the second intermediate straight portion 313. Similarly, the second proximal barb 308 has a sharp edge 320 characterized by a sharp corner 322 (back corner), formed at a transition from the sharp edge 320 to the proximal straight portion 315.

With this configuration, the first proximal barb 307 and the second proximal barb 308 facilitate gripping the interior peripheral surface of the elastomeric inner tube 102 of the refrigerant hose 100 and enhance retention of the refrigerant hose 100 to the fitting 300. As mentioned above, the term “sharp corner” is used herein to indicate that, to the extent the sharp corner 319 and/or the sharp corner 322 has any curvature or radius, such curvature or radius is an order of magnitude smaller than a respective curvature or radius of the curved edge 316 of the distal barb 306.

In examples, the fitting 300 may be suitable for a larger size refrigerant hose compared to the fitting 200. As an example for illustration, the outer diameter D of the distal barb 206 of the fitting 200 can be about 0.5 inch, suitable for optimal compression of layers of a refrigerant hose having an inner diameter of 0.420 inches, while the outer diameter D of the distal barb 306 of the fitting 300 can be about 1 inch suitable for optimal compression of layers of a refrigerant hose having an inner diameter of 0.895 inches.

Thus, it should be understood that the disclosed fitting can have at least one distal barb with a curved edge and at least one proximal barb with a sharp edge and sharp corner. However, more barbs of each type are contemplated.

To mount the refrigerant hose 100 onto the fitting 200, 300 (or insert the fitting 200, 300 into the refrigerant hose 100), the refrigerant hose 100 can be cut squarely to a desired length. The barbed portion 204, 304 of the fitting 200, 300, the interior surface of the elastomeric inner tube 102 of the refrigerant hose 100, or both may then be lubricated (e.g., with light oil or soapy water).

FIG. 4 illustrates mounting the refrigerant hose 100 to the fitting 200, 300 to form an assembly 400, according to an example implementation. The assembly 400 is shown in FIG. 4 in a partially formed state during insertion of the fitting 200, 300 into the elastomeric inner tube 102 of the refrigerant hose 100. However, it should be understood that the assembly 400 is formed or completed when the end of the refrigerant hose reaches or interfaces with the head portion 202, 302 of the fitting 200, 300.

Referring to FIGS. 1-4 together, after lubrication, the fitting 200, 300 can be inserted into the refrigerant hose 100 until the distal barb 206, 306 is disposed within the elastomeric inner tube 102 of the refrigerant hose 100. As the elastomeric inner tube 102 is installed on the fitting 200, 300, it expands over the distal barb 206, 306. The curved edge 216, 316 of the distal barb 206 facilitates insertion of the fitting 200, 300 into the refrigerant hose 100. The ridge of the distal barb 206, 306 grips the interior wall of the elastomeric inner tube 102 without damaging it, providing a sealing surface.

The fitting 200, 300 may then be placed against a flat object 402 (e.g., work bench, wall, or a manifold). A user or technician may then grip the outer cover layer 110 of refrigerant hose 100 (e.g., approximately one inch from the end of the refrigerant hose 100), and then the technician may push with a steady force on the refrigerant hose 100 until the end of the refrigerant hose 100 reaches or interfaces with the head portion 202, 302 of the fitting 200, 300. The sharp edge 218, 318, 320 (and/or the sharp corners 219, 319, 322) of the proximal barb 208, 307, 308 enhances the grip of the fitting 200, 300 with the refrigerant hose 100, further enhancing the sealed connection therebetween, without damaging the elastomeric inner tube 102 or the barrier layer 104 of the refrigerant hose 100.

As crimping of the fitting 200, 300 is not needed, thus mounting the refrigerant hose 100 to the fitting 200, 300 can advantageously be accomplished in a field environment. Further, numerous such connections can be accomplished in a time-efficient manner.

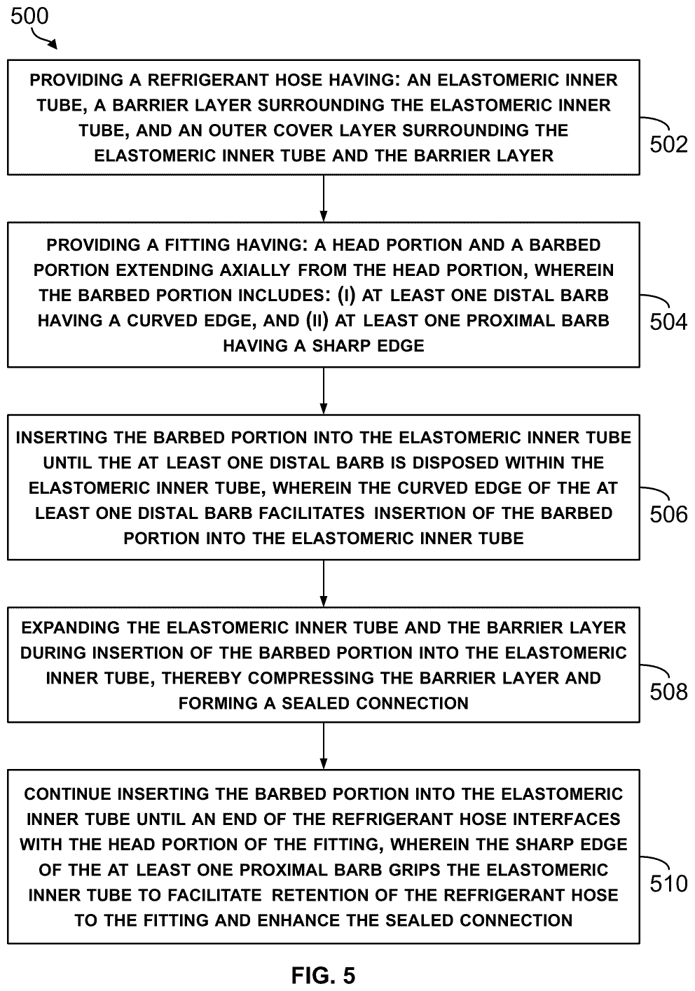

FIG. 5 is a flowchart of a method 500 of forming the assembly 400 of FIG. 4, according to an example implementation. The method 500 may include one or more operations, functions, or actions as illustrated by one or more of blocks 502-510. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 502, the method 500 includes providing the refrigerant hose 100 having: the elastomeric inner tube 102, the barrier layer 104 surrounding the elastomeric inner tube 102, and the outer cover layer 110 surrounding the elastomeric inner tube 102 and the barrier layer 104.

At block 504, the method 500 includes providing the fitting 200, 300 having: the head portion 202, 302 and the barbed portion 204, 304 extending axially from the head portion 202, 302, wherein the barbed portion 204, 304 includes: (i) at least one distal barb 206, 306 having the curved edge 216, 316, and (ii) at least one proximal barb (the proximal barb 208, 307, 308) having a sharp edge (the sharp edge 218, 318, 320).

The term “providing” as used herein, and for example with regard to the refrigerant hose 100 or the fitting 200, 300, includes any action to make the refrigerant hose 100 or the fitting 200, 300 available for use, such as bringing the refrigerant hose 100 or the fitting 200, 300 to an apparatus or to a work environment for further processing (e.g., mounting other components).

At block 506, the method 500 includes inserting the barbed portion 204, 304 into the elastomeric inner tube 102 until the at least one distal barb 206, 306 is disposed within the elastomeric inner tube 102, wherein the curved edge 216, 316 of the at least one distal barb 206, 306 facilitates insertion of the barbed portion 204, 304 into the elastomeric inner tube 102.

At block 508, the method 500 includes expanding the elastomeric inner tube 102 and the barrier layer 104 during insertion of the barbed portion 204, 304 into the elastomeric inner tube 102, thereby compressing the barrier layer 104 and forming a sealed connection.

At block 510, the method 500 includes continue inserting the barbed portion 204, 304 into the elastomeric inner tube 102 until an end of the refrigerant hose 100 interfaces with the head portion 202, 302 of the fitting 200, 300, wherein the sharp edge (the sharp edge 218, 318, 320) of the at least one proximal barb (the proximal barb 208, 307, 308) grips the elastomeric inner tube 102 to facilitate retention of the refrigerant hose 100 to the fitting 200, 300 and enhance the sealed connection.

The method 500 can further include any of the other steps or operations described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform actuators presented in the figures. In some instances, components of the devices and/or systems may be configured to perform the actuators such that the components are actually configured and structured (with hardware and/or software) to enable such performance. In other examples, components of the devices and/or systems may be arranged to be adapted to, capable of, or suited for performing the actuators, such as when operated in a specific manner.

By the term “substantially” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a fitting comprising: a head portion; and a barbed portion extending axially from the head portion, wherein the barbed portion includes: at least one distal barb having a curved edge, and at least one proximal barb having a sharp edge.

EEE 2 is the fitting of EEE 1, wherein the barbed portion further comprises: a distal straight portion followed by a first ramp that leads to the at least one distal barb; an intermediate straight portion that is interposed between the at least one distal barb and a second ramp that leads to the at least one proximal barb; and a proximal straight portion that is interposed between the at least one proximal barb and the head portion.

EEE 3 is the fitting of EEE 2, wherein the sharp edge has a sharp corner formed at a transition from the at least one proximal barb to the proximal straight portion.

EEE 4 is the fitting of EEE 3, wherein the sharp corner has a radius that is an order of magnitude smaller than a respective radius of the curved edge of the at least one distal barb.

EEE 5 is the fitting of any of EEEs 1-4, wherein the barbed portion has a smaller outer diameter compared to the head portion.

EEE 6 is the fitting of any of EEEs 1-5, wherein an outer diameter of the at least one distal barb is substantially equal to a respective outer diameter of the at least one proximal barb.

EEE 7 is the fitting of any of EEEs 1-6, wherein the at least one proximal barb comprises: a first proximal barb; and a second proximal barb, wherein the first proximal barb is axially interposed between the at least one distal barb and the second proximal barb.

EEE 8 is the fitting of EEE 7, wherein the barbed portion further comprises: a distal straight portion followed by a first ramp that leads to the at least one distal barb; a first intermediate straight portion that is interposed between the at least one distal barb and a second ramp that leads to the first proximal barb; a second intermediate straight portion that is interposed between the first proximal barb and a third ramp that leads to the second proximal barb; and a proximal straight portion that is interposed between the second proximal barb and the head portion.

EEE 9 is the fitting of EEE 8, wherein the first proximal barb has a sharp corner formed at a transition from the first proximal barb to the second intermediate straight portion, and wherein the second proximal barb has a respective sharp corner formed at a respective transition from the second proximal barb to the proximal straight portion.

EEE 10 is the fitting of EEE 9, wherein the sharp corner has a first radius and the respective sharp corner has a second radius, and wherein the first radius and the second radius are an order of magnitude smaller than a respective radius of the curved edge of the at least one distal barb.

EEE 11 is an assembly comprising: a refrigerant hose comprising an elastomeric inner tube, a barrier layer surrounding the elastomeric inner tube, and an outer cover layer surrounding the elastomeric inner tube and the barrier layer; and the fitting of any of EEEs 1-10. For example, the fitting comprises: a head portion interfacing with an end of the refrigerant hose, and a barbed portion extending axially from the head portion and inserted into the elastomeric inner tube of the refrigerant hose, wherein the barbed portion includes: (i) at least one distal barb having a curved edge to facilitate insertion of the barbed portion into the elastomeric inner tube, and (ii) at least one proximal barb having a sharp edge to enhance grip between the fitting and the elastomeric inner tube, wherein the fitting expands the elastomeric inner tube and the barrier layer, thereby compressing the barrier layer and forming a sealed connection.

EEE 12 is the assembly of EEE 11, wherein the refrigerant hose further comprises: an elastomeric layer surrounding the barrier layer; and a braided layer surrounding the elastomeric layer, wherein the outer cover layer surrounds the braided layer.

EEE 13 is the assembly of any of EEEs 11-12, wherein the barbed portion of the fitting further comprises: a distal straight portion followed by a first ramp that leads to the at least one distal barb; an intermediate straight portion that is interposed between the at least one distal barb and a second ramp that leads to the at least one proximal barb; and a proximal straight portion that is interposed between the at least one proximal barb and the head portion.

EEE 14 is the assembly of EEE 13, wherein the sharp edge has a sharp corner formed at a transition from the at least one proximal barb to the proximal straight portion.

EEE 15 is the assembly of EEE 14, wherein the sharp corner has a radius that is an order of magnitude smaller than a respective radius of the curved edge of the at least one distal barb.

EEE 16 is the assembly of any of EEEs 11-15, wherein the barbed portion has a smaller outer diameter compared to the head portion.

EEE 17 is the assembly of any of EEEs 11-16, wherein an outer diameter of the at least one distal barb is substantially equal to a respective outer diameter of the at least one proximal barb.

EEE 18 is the assembly of any of EEEs 11-17, wherein the at least one proximal barb comprises: a first proximal barb; and a second proximal barb, wherein the first proximal barb is axially interposed between the at least one distal barb and the second proximal barb.

EEE 19 is the assembly of EEE 18, wherein the barbed portion further comprises: a distal straight portion followed by a first ramp that leads to the at least one distal barb; a first intermediate straight portion that is interposed between the at least one distal barb and a second ramp that leads to the first proximal barb; a second intermediate straight portion that is interposed between the first proximal barb and a third ramp that leads to the second proximal barb; and a proximal straight portion that is interposed between the second proximal barb and the head portion.

EEE 20 is the assembly of EEE 19, wherein the first proximal barb has a sharp corner formed at a transition from the first proximal barb to the second intermediate straight portion, and wherein the second proximal barb has a respective sharp corner formed at a respective transition from the second proximal barb to the proximal straight portion, wherein the sharp corner has a first radius and the respective sharp corner has a second radius, and wherein the first radius and the second radius are an order of magnitude smaller than a respective radius of the curved edge of the at least one distal barb.

EEE 21 is a method of forming the assembly of any of EEEs 11-20. For example, the method comprises: providing the refrigerant hose of any of EEEs 11-20 having: an elastomeric inner tube, a barrier layer surrounding the elastomeric inner tube, and an outer cover layer surrounding the elastomeric inner tube and the barrier layer; providing the fitting of any of EEEs 1-10 having: a head portion and a barbed portion extending axially from the head portion, wherein the barbed portion includes: (i) at least one distal barb having a curved edge, and (ii) at least one proximal barb having a sharp edge; inserting the barbed portion into the elastomeric inner tube until the at least one distal barb is disposed within the elastomeric inner tube, wherein the curved edge of the at least one distal barb facilitates insertion of the barbed portion into the elastomeric inner tube; expanding the elastomeric inner tube and the barrier layer during insertion of the barbed portion into the elastomeric inner tube, thereby compressing the barrier layer and forming a sealed connection; and continue inserting the barbed portion into the elastomeric inner tube until an end of the refrigerant hose interfaces with the head portion of the fitting, wherein the sharp edge of the at least one proximal barb grips the elastomeric inner tube to facilitate retention of the refrigerant hose to the fitting and enhance the sealed connection.

EEE 22 is the method of EEE 21, further comprising: lubricating the barbed portion of the fitting and/or an interior surface of the elastomeric inner tube of the refrigerant hose prior to inserting the barbed portion into the elastomeric inner tube.

EEE 23 is the method of any of EEEs 21-22, further comprising: after inserting the barbed portion into the elastomeric inner tube until the at least one distal barb is disposed within the elastomeric inner tube, placing the fitting against a flat object; gripping the outer cover layer of the refrigerant hose; and pushing the refrigerant hose until the end of the refrigerant hose interfaces with the head portion of the fitting.

What is claimed is:

1. A fitting comprising:
a head portion; and
a barbed portion extending axially from the head portion, wherein the barbed portion includes:
at least one distal barb having a curved edge, and
at least one proximal barb having a sharp edge.

2. The fitting of claim 1, wherein the barbed portion further comprises:
a distal straight portion followed by a first ramp that leads to the at least one distal barb;
an intermediate straight portion that is interposed between the at least one distal barb and a second ramp that leads to the at least one proximal barb; and
a proximal straight portion that is interposed between the at least one proximal barb and the head portion.

3. The fitting of claim 2, wherein the sharp edge has a sharp corner formed at a transition from the at least one proximal barb to the proximal straight portion.

4. The fitting of claim 3, wherein the sharp corner has a radius that is an order of magnitude smaller than a respective radius of the curved edge of the at least one distal barb.

5. The fitting of claim 1, wherein the barbed portion has a smaller outer diameter compared to the head portion.

6. The fitting of claim 1, wherein an outer diameter of the at least one distal barb is substantially equal to a respective outer diameter of the at least one proximal barb.

7. The fitting of claim 1, wherein the at least one proximal barb comprises:
a first proximal barb; and
a second proximal barb, wherein the first proximal barb is axially interposed between the at least one distal barb and the second proximal barb.

8. The fitting of claim 7, wherein the barbed portion further comprises:
a distal straight portion followed by a first ramp that leads to the at least one distal barb;
a first intermediate straight portion that is interposed between the at least one distal barb and a second ramp that leads to the first proximal barb;
a second intermediate straight portion that is interposed between the first proximal barb and a third ramp that leads to the second proximal barb; and
a proximal straight portion that is interposed between the second proximal barb and the head portion.

9. The fitting of claim 8, wherein the first proximal barb has a sharp corner formed at a transition from the first proximal barb to the second intermediate straight portion, and wherein the second proximal barb has a respective sharp corner formed at a respective transition from the second proximal barb to the proximal straight portion.

10. The fitting of claim 9, wherein the sharp corner has a first radius and the respective sharp corner has a second radius, and wherein the first radius and the second radius are an order of magnitude smaller than a respective radius of the curved edge of the at least one distal barb.

11. An assembly comprising:
a refrigerant hose comprising:
an elastomeric inner tube,
a barrier layer surrounding the elastomeric inner tube, and
an outer cover layer surrounding the elastomeric inner tube and the barrier layer; and
a fitting comprising:
a head portion interfacing with an end of the refrigerant hose, and
a barbed portion extending axially from the head portion and inserted into the elastomeric inner tube of the refrigerant hose, wherein the barbed portion includes: (i) at least one distal barb having a curved edge to facilitate insertion of the barbed portion into the elastomeric inner tube, and (ii) at least one proximal barb having a sharp edge to enhance grip between the fitting and the elastomeric inner tube, wherein the fitting expands the elastomeric inner tube and the barrier layer, thereby compressing the barrier layer and forming a sealed connection.

12. The assembly of claim 11, wherein the refrigerant hose further comprises:
an elastomeric layer surrounding the barrier layer; and
a braided layer surrounding the elastomeric layer, wherein the outer cover layer surrounds the braided layer.

13. The assembly of claim 11, wherein the barbed portion of the fitting further comprises:
a distal straight portion followed by a first ramp that leads to the at least one distal barb;
an intermediate straight portion that is interposed between the at least one distal barb and a second ramp that leads to the at least one proximal barb; and
a proximal straight portion that is interposed between the at least one proximal barb and the head portion.

14. The assembly of claim 13, wherein the sharp edge has a sharp corner formed at a transition from the at least one proximal barb to the proximal straight portion.

15. The assembly of claim 14, wherein the sharp corner has a radius that is an order of magnitude smaller than a respective radius of the curved edge of the at least one distal barb.

16. The assembly of claim 11, wherein the barbed portion has a smaller outer diameter compared to the head portion.

17. The assembly of claim 11, wherein an outer diameter of the at least one distal barb is substantially equal to a respective outer diameter of the at least one proximal barb.

18. The assembly of claim 11, wherein the at least one proximal barb comprises:
a first proximal barb; and
a second proximal barb, wherein the first proximal barb is axially interposed between the at least one distal barb and the second proximal barb.

19. The assembly of claim 18, wherein the barbed portion further comprises:
a distal straight portion followed by a first ramp that leads to the at least one distal barb;
a first intermediate straight portion that is interposed between the at least one distal barb and a second ramp that leads to the first proximal barb;
a second intermediate straight portion that is interposed between the first proximal barb and a third ramp that leads to the second proximal barb; and
a proximal straight portion that is interposed between the second proximal barb and the head portion.

20. The assembly of claim 19, wherein the first proximal barb has a sharp corner formed at a transition from the first proximal barb to the second intermediate straight portion, and wherein the second proximal barb has a respective sharp corner formed at a respective transition from the second proximal barb to the proximal straight portion, wherein the sharp corner has a first radius and the respective sharp corner has a second radius, and wherein the first radius and the second radius are an order of magnitude smaller than a respective radius of the curved edge of the at least one distal barb.
